(19) United States
(12) Patent Application Publication
(10) Pub. No.: US 2011/0044882 A1
(43) Pub. Date: Feb. 24, 2011

(54) METHOD OF MAKING HIGH PURITY LITHIUM HYDROXIDE AND HYDROCHLORIC ACID

(76) Inventors: David Buckley, Gastonia, NC (US); J. David Genders, Elma, NY (US); Dan Atherton, Lancaster, NY (US)

Correspondence Address: FULBRIGHT & JAWORSKI, LLP, 666 FIFTH AVE, NEW YORK, NY, 10103-3198, US

(21) Appl. No.: 12/935,658

(22) PCT Filed: Apr. 9, 2009
(86) PCT No.: PCT/US09/02227

§ 371 Date: Nov. 15, 2010

Related U.S. Application Data
(60) Provisional application No. 61/125,011, filed on Apr. 22, 2008.

(51) Int. Cl. C01B 7/01; C01D 15/02; C25B 1/34

(52) U.S. Cl. 423/481; 423/641; 205/536; 205/532

(57) ABSTRACT

The present invention relates to a process for producing high purity lithium hydroxide monohydrate, comprising following steps: concentrating a lithium containing brine; purifying the brine to remove or to reduce the concentrations of ions other than lithium; adjusting the pH of the brine to about 10.5 to 11 to further remove cations other than lithium, if necessary; neutralizing the brine with acid; purifying the brine to reduce the total concentration of calcium and magnesium to less than 150 ppb via ion exchange; electrolyzing the brine to generate a lithium hydroxide solution containing less than 150 ppb total calcium and magnesium, with chlorine and hydrogen gas as byproducts; producing hydrochloric acid via combustion of the chlorine gas with excess hydrogen and subsequent scrubbing of the resultant gas stream with purified water, if elected to do so; and concentrating and crystallizing the lithium hydroxide solution to produce lithium hydroxide monohydrate crystals.

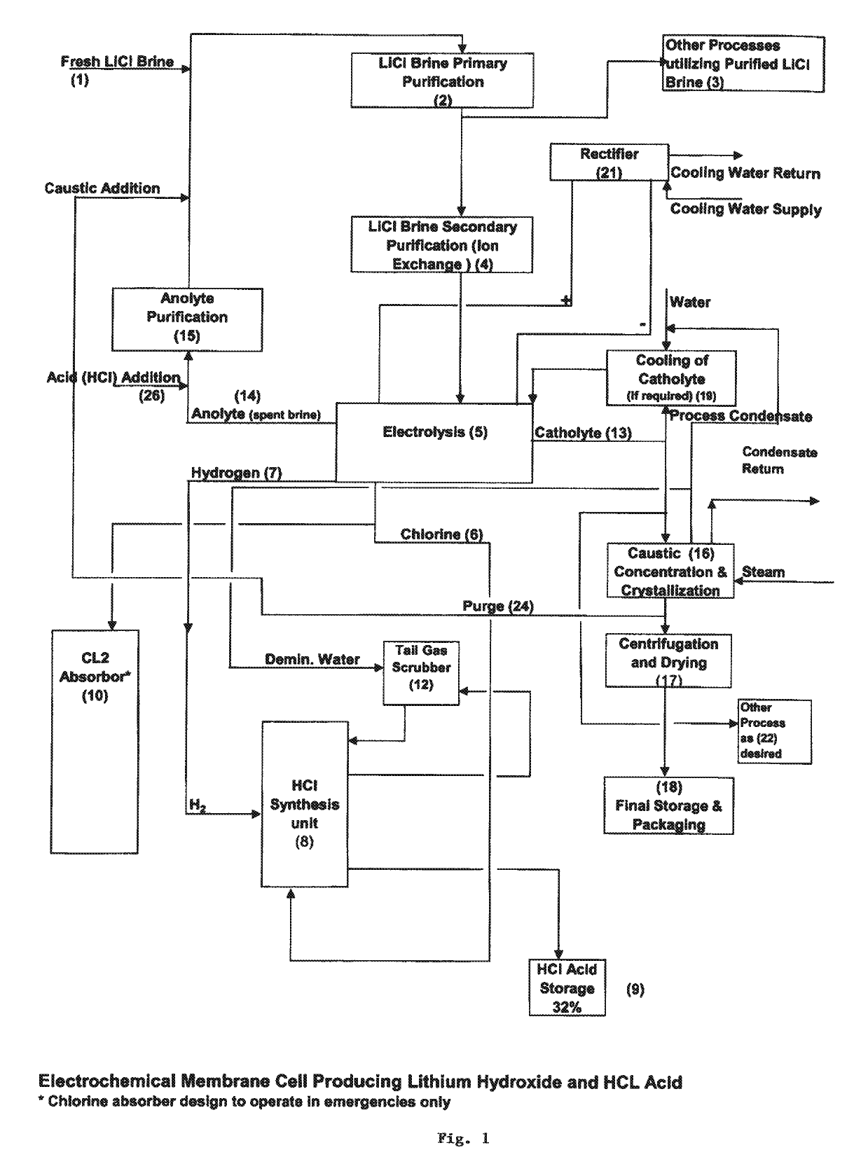

This application claims the benefit under 35 U.S.C. §119 (e) of U.S. Provisional Patent Application Ser. No. 61/125,011 filed Apr. 22, 2008, hereby incorporated by reference in its entirety for all purposes.

### FIELD OF THE INVENTION

The present invention relates to a process for producing high purity lithium products, especially lithium hydroxide monohydrate, for use in commercial applications, in particular, in battery applications.

### BACKGROUND OF THE INVENTION

Lithium hydroxide monohydrate (LiOH.H₂O) can be produced via an aqueous causticization reaction between slaked lime (Ca(OH)₂) and lithium carbonate (Li₂CO₃). Slaked lime can be formed from calcium oxide (CaO) that is hydrated with water (H₂O). This produces an approximately 3% LiOH aqueous solution that is then concentrated to a saturated solution and crystallized via standard industry practices. The reactions are shown below:

CaO+H₂O═Ca(OH)₂+heat

Li₂CO₃+Ca(OH)₂=2LiOH(aq)+CaCO₃

2LiOH(aq)=2LiOH.H₂O(lithium hydroxide monohydrate)

The lithium source can either be brine-based or ore-based. As the starting material, lithium carbonate can be derived from either a natural or synthetic source. Ultimately, the purity of the final product is impacted by the quality of the starting materials, lithium carbonate, lime and the quality of the water used to make the aqueous solutions.

Lithium hydroxide monohydrate is increasingly being used for various battery applications. Battery application typically requires very low levels of impurities, notably sodium, calcium and chlorides. Obtaining a lithium hydroxide product with a low calcium level is difficult when using a calcium-based compound such as lime as a base, unless one or more purification steps are performed. These additional purification steps add to the time and cost of manufacture of the desired lithium hydroxide product.

Additionally, natural brines generally contain only very small amounts of lithium, although natural “concentrated” brines containing up to about 0.5% lithium are occasionally found. Many of these natural brines, however, are associated with high concentrations of magnesium or other metals which make lithium recovery uneconomical. Thus, the production of lithium hydroxide monohydrate from natural brines presents a very difficult task, not only because of the economics of working with the very low concentrations of lithium which occur in nature; additionally, it is difficult to separate lithium compounds in a useful degree of purity from closely chemically related materials with which lithium salts are normally contaminated, e.g., sodium salts. It is also particularly difficult to yield significantly pure lithium hydroxide monohydrate using the typical processes that utilize a compound that contains calcium, e.g., slaked lime, during production. Nevertheless, the demand for lithium is growing rapidly, and new methods for producing high purity lithium products, especially lithium hydroxide monohydrate, are required.

U.S. Pat. No. 7,157,065 B2 describes, among other things, methods and apparatus for the production of low sodium lithium carbonate and lithium chloride from a brine concentrated to about 6.0 wt % lithium are disclosed. Methods and apparatus for direct recovery of technical grade lithium chloride from the concentrated brine are also disclosed.

Prior attempts to recover lithium compounds from natural brines and/or to produce lithium products therefrom have been described in the literature.

U.S. Pat. No. 4,036,713 describes a process for producing high purity lithium hydroxide from a brine, natural or other resource containing lithium and other alkali and alkaline earth metals primarily as the halides. A lithium source is preliminarily concentrated to a lithium content of about 2 to 7% to separate most of the alkali and alkaline earth metals other than lithium by precipitation; the pH of such a concentrated brine is then increased to about 10.5 to about 11.5, preferably utilizing a product of the process, lithium hydroxide to precipitate substantially all of any remaining magnesium contaminants, and adding lithium carbonate to remove the calcium contaminants to provide a purified brine; said purified brine is then electrolyzed as the anolyte in a cell having a cation selective permeable membrane separating the anolyte from the catholyte, the latter being of water or aqueous lithium hydroxide, whereby the lithium ions migrate through the membrane to form substantially pure aqueous lithium hydroxide in the catholyte, a product from which highly pure lithium crystalline compounds such as lithium hydroxide monohydrate or lithium carbonate may be separated.

The Kirk-Othmer Encyclopedia of Chemical Technology, Second Edition, Supplement Volume, pages 438-467, discusses the brines of the Great Salt Lake of Utah and the attempts to date to recover various chemical values from them. It is particularly interesting to note that brines from this source vary widely in composition, not only from place to place in the lake, but also from year to year. This reference describes a number of different methods which have been proposed for the recovery of lithium values from these brines, including: evaporation-crystallization-thermal decomposition; ion exchange; lithium aluminum complexing; and solvent extraction. It appears that all of these previously proposed methods are complex and expensive and fail to provide products of sufficiently high purity for use in most commercial applications.

U.S. Pat. No. 2,004,018 describes a method of the prior art for separating lithium salts from mixtures with the salts of other alkali and alkaline earth metals, in which the mixed salts are initially converted to the sulfates and then treated with aluminum sulfate to remove the bulk of the potassium as a precipitate. Controlled amounts of soluble carbonate are then added to the solution to first remove the magnesium and calcium carbonates, and then to precipitate and separate lithium carbonate from the other alkali metal carbonates which remain in solution. Rosett et al. prefer, however, to work with the chlorides which are obtained by treating the mixed salts with hydrochloric acid. The resulting solution is concentrated by boiling until the boiling point is such that, on cooling, the largest possible amount of mixed alkali metal chlorides precipitates, leaving the lithium chloride in solution. The solution may then be further concentrated to such a point that, on cooling, the lithium chloride precipitates out in the form of monohydrate.

U.S. Pat. No. 2,726,138 relates to a process for preparing so-called high-purity lithium chloride by first concentrating a crude aqueous solution containing about 2% total of lithium, sodium and potassium chlorides, to a concentration of about 40-44% lithium chloride by evaporation at elevated temperatures so that on cooling to 25°-50° C., the sodium and potassium chlorides precipitate out leaving the more soluble lithium chloride in solution. The resulting solution is then extracted with an inert organic solvent for the lithium chloride.

U.S. Pat. No. 3,523,751 relates to the precipitation of lithium carbonate from lithium chloride solution by the addition of sodium carbonate. It is further incidentally disclosed that lithium hydroxide solutions are readily carbonated to precipitate lithium carbonate. It is also noted that the reaction of lithium chloride solution with sodium carbonate results in the precipitation of lithium carbonate.

U.S. Pat. No. 3,597,340 relates to the recovery of lithium hydroxide monohydrate from aqueous chloride brines containing both lithium chloride and sodium chloride, by electrolyzing the brines in a diaphragm cell which maintains separation between the anolyte and catholyte; the diaphragm being of the conventional asbestos fiber mat type.

U.S. Pat. No. 3,652,202 describes a method for preparing alkali metal carbonate from carbonated aqueous alkali metal hydroxide cell liquor prepared by electrolysis of alkali metal chloride in an electrolytic cell by contacting the carbonated cell liquor with atapulgite type clay, and, thereafter, crystallizing alkali metal carbonate from the so-treated cell liquor.

U.S. Pat. No. 3,268,289 describes the concentration of Great Salt Lake brines by solar evaporation and means for increasing the ratio of lithium chloride to magnesium chloride in the concentrated brine. It is said that the resulting brine may then be processed in various ways such as removing the magnesium in an electrolytic cell, or oxidizing the magnesium to magnesium oxide.

U.S. Pat. No. 3,755,533 describes a method for separating lithium salts from other metal salts by complexing with monomeric or polymeric organic chelating agents.

The aforementioned methods for yielding lithium from natural brines or mixtures of alkali and alkaline earth metal salts all involve difficult or expensive separations, and have not, in general, provided lithium products of sufficient purity for use in certain industrial applications.

### OBJECTS OF THE INVENTION

Thus, it is an object of the present invention to provide a relatively simple and economic process for the recovery of lithium values in the form of a lithium compound of high purity which is also readily convertible into other highly pure lithium compounds.

It is another object of this invention to provide an improved electrolytic process for the concentration of lithium values which is highly efficient and which may be operated for extended periods of time due to the absence of interfering cations.

It is a specific object of the invention to produce a highly pure aqueous solution of lithium hydroxide from which such valuable products as crystalline lithium hydroxide monohydrate and lithium carbonate may be readily separated.

These and other objects of the invention, which will become apparent hereinafter are achieved by the following process.

Importantly, while calcium and magnesium levels of sodium brines have been reduced to levels in the ppb range on a fairly routinely basis, levels of calcium and magnesium in lithium brines have proven extremely difficult to reduce to such levels, and it is not believed that they have not been reduced to levels of 150 ppb or less (combined), which is a significant advantage of the present invention. Thus, lithium brines having a combined level of less than 150 ppb, preferably less than 50 ppb each, are an important object of the present invention, as are method of obtaining such brines.

### SUMMARY OF THE INVENTION

The present invention relates to a process for producing high purity lithium products, especially lithium hydroxide monohydrate. The process is applicable to all lithium-containing aqueous brines, but natural aqueous brines are preferred. Lithium containing ore can also be used as a source provided a lithium-containing brine is produced therefrom.

The brine sources used may contain a variety of impurities, i.e., ions other than lithium, such as magnesium, calcium, sodium, potassium, etc. Prior to ion exchange purification, such impurities are preferably removed or reduced via suitable processes known in the art for removing or reducing the respective impurity.

After removing or reducing the impurities, the brine, with or without removal of the impurities, is then concentrated with respect to the lithium content. Preferably, the brine is concentrated to a lithium content of about 2 to 7% by weight and preferably from 2.8 to 6.0% by weight, or to about 12 to 44% by weight, and preferably 17 to 36% by weight calculated as lithium chloride, to cause the major portion of all sodium and potassium present to precipitate out of solution.

The pH of such a concentrated brine is then adjusted to about 10.5 to about 11.5, and preferably about 11, to precipitate di- or tri-valent ions such as iron, magnesium, and calcium. This may be accomplished by, e.g., adjusted by adding lithium hydroxide and lithium carbonate in amounts stoichiometrically equal to the content of iron, calcium and magnesium. The pH adjustment is preferably accomplished by adding a base, preferably a lithium containing base such as lithium hydroxide and lithium carbonate, which are preferably recovered products of the process. As a result of the Ph adjustment, a substantial amount of iron, calcium and magnesium are removed from the concentrated and pH adjusted brine.

Calcium and magnesium, as well as other di and tri-valent ions, may then be further reduced via ion exchange such that the end result is a brine containing less than 150 ppb of calcium and magnesium combined.

This more purified brine is then electrolyzed to yield a lithium hydroxide solution containing less than 150 ppb total calcium and magnesium. A semi-permeable membrane which selectively passes cations is employed in the electrolysis process, wherein the lithium ions migrate through the membrane to form substantially pure aqueous lithium hydroxide in the catholyte, a product from which highly pure lithium crystalline compounds such as lithium hydroxide monohydrate or lithium carbonate may be formed.

A particularly preferred process according to the invention relates to a process for producing lithium hydroxide monohydrate crystals by purifying a lithium containing brine that also contains sodium and optionally potassium to reduce the total concentration of calcium and magnesium to less than 150 ppb; electrolyzing the brine to generate a lithium hydroxide solution containing less than 150 ppb total calcium and magnesium, with chlorine and hydrogen gas as byproducts; and concentrating and crystallizing the lithium hydroxide solution to produce lithium hydroxide monohydrate crystals.

Another preferred method of the present invention relates to a process for producing hydrochloride acid by purifying a lithium containing brine that also contains sodium and optionally potassium to reduce the total concentration of calcium and magnesium to less than 150 ppb; electrolyzing the brine to generate a lithium hydroxide solution containing less than 150 ppb total calcium and magnesium, with chlorine and hydrogen gas as byproducts; and producing hydrochloric acid via combustion of the chlorine gas with excess hydrogen.

Another preferred process of the present invention relates to a process for producing both lithium hydroxide monohydrate and hydrochloride acid by purifying a lithium containing brine that also contains sodium and optionally potassium to reduce the total concentration of calcium and magnesium to less than 150 ppb; electrolyzing the brine to generate a lithium hydroxide solution containing less than 150 ppb total calcium and magnesium, with chlorine and hydrogen gas as byproducts; and concentrating and crystallizing the lithium hydroxide solution to produce lithium hydroxide monohydrate crystals; and producing hydrochloric acid via combustion of the chlorine gas with excess hydrogen.

Yet another preferred embodiment of the invention relates to a process for producing lithium hydroxide monohydrate crystals by concentrating a lithium containing brine that also contains sodium and optionally potassium to precipitate sodium an optionally potassium from the brine; optionally purifying the brine to remove or to reduce the concentrations of boron, magnesium, calcium, sulfate, and any remaining sodium or potassium; adjusting the pH of the brine to about 10.5 to 11 to further remove any cations other than lithium; further purifying the brine by ion exchange to reduce the total concentration of calcium and magnesium to less than 150 ppb; electrolyzing the brine to generate a lithium hydroxide solution containing less than 150 ppb total calcium and magnesium, with chlorine and hydrogen gas as byproducts; and concentrating and crystallizing the lithium hydroxide solution to produce lithium hydroxide monohydrate crystals.

In a preferred embodiment, the lithium hydroxide solution of the process is converted to a high purity lithium product, and more preferably high purity lithium carbonate, containing less than 150 ppb of calcium and magnesium combined.

In a particularly preferred embodiment, the lithium hydroxide monohydrate crystals are centrifuged, and recovered. The centrifuged or otherwise recovered crystals may optionally be dried, subsequently packaging of the dried material.

It is preferred that the brine is concentrated to a lithium concentration of from about 2% to about 7% preferably 6.5%, and more preferably 2.8 to 6.0% by wt. prior to electrolysis.

In yet another preferred embodiment, the lithium containing brine is concentrated via solar evaporation.

The amount of boron in the brine may optionally be reduced, e.g., via an organic extraction process or by ion exchange.

Magnesium is preferably reduced via the addition of or controlled reaction with lime or slaked lime, but lime is preferably used. Calcium is preferably reduced by addition of oxalic acid to precipitate calcium oxalate. Calcium and magnesium may also be removed via ion exchange, or by a combination of any known means in the art to reduce these ions in a lithium brine.

Sulfate may optionally be reduced, e.g., by addition of barium to precipitate barium sulfate.

Sodium may be reduced by via fractional crystallization or other means, if desired or necessary.

For the electrolysis, the electrodes are preferably made of highly corrosive-resistant material. Electrodes are made in a particularly preferred embodiment of coated titanium and nickel. In another preferred embodiment, during the electrolysis step, the electrochemical cell is arranged in a “pseudo zero gap” configuration. It is particularly preferred that during the electrolysis step, a monopolar membrane cell is used, e.g., an Ineos Chlor FM1500 monopolar membrane.

In preferred embodiments, the cathode side electrode is a lantern blade design to promote turbulence and gas release during hydrolysis.

A preferred process of the present invention relates to a producing hydrochloric acid by (a) concentrating a lithium containing brine that also contains sodium and optionally potassium to precipitate sodium and optionally potassium from the brine; purifying the brine to remove or to reduce the concentrations of boron, if necessary, magnesium, calcium, sulfate, and any remaining sodium or potassium; adjusting the pH of the brine to about 10.5 to 11 to further remove any cations other than lithium; further purifying the brine by ion exchange to reduce the total concentration of calcium and magnesium to less than 150 ppb; electrolyzing the brine to generate a lithium hydroxide solution containing less than 150 ppb total calcium and magnesium, with chlorine and hydrogen gas as byproducts; and producing hydrochloric acid via combustion of the chlorine gas with excess hydrogen. Any of the embodiments may be incorporated into this process as desired, e.g., to reduce the presence of undesirable ions such as calcium and magnesium.

The invention also relates to lithium hydroxide monohydrate containing less than 150 ppb Ca and Mg combined total, and preferably less than 50 ppb total, and most preferably less than 15 ppb combined total.

Another aspect of the invention relates to aqueous lithium hydroxide containing less than 150 ppb total Ca and Mg and preferably less than 50 ppb total, and most preferably less than 15 ppb combined total.

Products or other products of manufacture, e.g., batteries, which incorporate the aforementioned lithium hydroxide monohydrate and/or aqueous lithium hydroxide solutions are also an aspect of the invention.

### BRIEF DESCRIPTION OF THE FIGURE

The FIGURE shows a flow diagram of a preferred process according to the present invention.

### DETAILED DESCRIPTION

The present invention generally relates to a process for producing either lithium hydroxide monohydrate, hydrochloride acid or both, by purifying a lithium containing brine that also contains sodium and optionally potassium to reduce the total concentration of calcium and magnesium to less than 150 ppb; electrolyzing the brine to generate a lithium hydroxide solution containing less than 150 ppb total calcium and magnesium, with chlorine and hydrogen gas as byproducts; and then performing at least one of the following steps: concentrating the lithium hydroxide solution to crystallize lithium hydroxide monohydrate crystals; or additionally producing hydrochloric acid via combustion of the chlorine gas with excess hydrogen.

In preferred embodiments, the process for the production of lithium hydroxide monohydrate and hydrochloride acid according to the present invention typically involves the steps of: concentrating a lithium containing brine via, e.g., solar evaporation or by heating; preferably reducing any boron impurities that may be contained in the brine via, e.g., an organic extraction process or ion exchange process, if desired; reducing magnesium content, if any, via a controlled reaction with lime and/or slaked lime to precipitate magnesium hydroxide, as desired; initially reducing any calcium, e.g., via oxalic acid treatment to precipitate calcium oxalate, if desired. Sulfate may be reduced via treatment, e.g., with barium, if desired. The sodium level in the brine may be reduced by, e.g., via fractional crystallization. Importantly, the levels of Ca and Mg are reduced to less than 150 ppb (combined total) and, more preferably, to less than 50 ppb (combined total), and most preferably less than 15 ppb (combined total) via ion exchange, alone or in combination with other processes, e.g., by precipitation, such as described above.

The resultant purified lithium-containing aqueous solution having less then 150 ppb Ca and Mg (combined total) is then electrochemically separated to a lithium hydroxide solution, with chlorine and hydrogen gas produced as byproducts. Water may optionally then be electrochemically generated by separating water to yield a hydrogen gas stream. The chlorine and hydrogen gas streams are optionally dried.

Hydrochloric acid may then be produced by via combustion of the chlorine gas with excess hydrogen and subsequent scrubbing of the resultant gas stream with purified water.

The lithium hydroxide solution may then be concentrated or otherwise modified to produce lithium hydroxide monohydrate crystals by, e.g., vacuum cooling or evaporation, to yield a lithium hydroxide monohydrate product that is sufficiently pure for battery applications, e.g., containing less than 150 ppb Ca and Mg (combined total), and preferably less than 50 ppb total, and most preferably less than 15 ppb (combined total).

Centrifuging the crystals, optionally with washing, increases purity but is not required.

The crystals may optionally be dried, preferably after washing, to yield a pure monohydrate crystal and subsequent packaging of the dried material.

The starting brine used will, of course, vary in ion content depending upon the source, so the process will be modified accordingly. For example, prior to the ion exchange purification, it will typically be necessary to purify the brine to remove or reduce unwanted ion concentrations, e.g., Ca, Mg, B, Fe, Na, sulfate, etc. Such removal processes are known in the art, and others that are developed may also be used. In a preferred embodiment, one practicing the process of the present invention will use a brine containing lithium which will typically contain other alkali and alkaline earth metals, primarily as the ionized halide salts. The brine may first be concentrated by any suitable means to a lithium concentration of from about 2 to about 7%, by weight, thus causing the major portion of all sodium and potassium present to precipitate out of the brines as the halides which are insoluble in a lithium halide solution of that concentration, i.e. about 12 to about 44%, calculated as lithium chloride. On the other end of the scale, while it is possible to electrolyze a brine approaching saturation in lithium chloride, i.e. about 44% (7.1% lithium), it is preferred not to use such concentrated brines because the tendency for chloride migration across the membrane increases. Therefore, it is most practical to employ as the analyte a brine containing about 2 to 5% lithium or about 12% to about 30% lithium chloride for best results and efficiency.

After separation of the sodium and potassium salts, the pH of the brine is adjusted to a value in the range from about 10.5 to about 11.5, preferably about 11 and lithium carbonate is added to cause any remaining calcium and/or magnesium and any iron present to precipitate to reduce or eliminate the presence of these ions. This pH adjustment may be made by any suitable means, but it is preferred to accomplish it by the addition of lithium hydroxide and lithium carbonate, both of which are easily obtainable from the product of the process as will be seen below. The addition of lithium hydroxide and lithium carbonate in amounts stoichiometrically equal to the content of iron, calcium and magnesium, results in substantially complete removal of these cations as the insoluble iron and magnesium hydroxides, and calcium carbonate.

The resulting brine, from which substantially all cations other than lithium have been removed or substantially removed to within desired limits is then preferably neutralized, preferably with hydrochloric acid or other suitable mineral or organic acid, and treated with an ion exchange resin to further reduce calcium and magnesium levels. This more purified brine is then subjected to electrolysis to yield a lithium hydroxide solution containing less than 150 ppb total Ca and Mg, and may be evaporated or heated to crystallize lithium hydroxide monohydrate of the same purity, which may be used, e.g., in battery applications.

The product of this process, substantially pure aqueous lithium hydroxide containing less than 150 ppb total Ca and Mg more preferably less than 50 ppb (total), and most preferably less than 15 ppb (total), is readily converted to other high purity lithium products of commercial utility as a solution or after it is precipitated to yield the monohydrate salt. For example, the solution may be treated with carbon dioxide to preferentially precipitate high purity lithium carbonate. Alternatively, the aqueous lithium hydroxide may be evaporated either partially or completely to produce high purity lithium hydroxide monohydrate.

A particularly preferred practice is to partially evaporate the solution to crystallize high purity lithium hydroxide monohydrate and recycle the remaining solution with freshly prepared solution, with a bleed, since the crystalline lithium hydroxide monohydrate produced in this way is of even higher purity than could otherwise be produced. The lithium products produced in this way are of very high purity and, indeed, will contain a maximum residual chloride of 0.05%, with a content of 0.01% chloride being more typical. This is very important in many applications such as where the lithium hydroxide is to be used in greases which must contain a minimum of chloride ion due to its corrosion potential. Also, if chloride is not excluded, as in a cell utilizing a typical industrial monopolar membrane, it is extremely difficult to produce a high purity lithium hydroxide by recrystallization.

The reason it is necessary in the process of the present invention to reduce to a minimum the concentration of cations other than lithium in the brine to be electrolyzed is to ensure production of high purity lithium hydroxide, but is also necessary because certain cations such as calcium, magnesium, and iron have a tendency to precipitate in the selective cation permeable membrane as the insoluble calcium, magnesium, and iron hydroxides. Such precipitation is, of course, highly undesirable since it not only reduces the efficiency of the membrane in passing the lithium ions, but also greatly shortens the useful life of the electrolysis membrane and thus the possible period of continuous operation of the cell, adding to the cost of preparation.

The process of the present invention may be performed on any natural or synthetic lithium brine. The starting brine will also typically contain as an impurity one or more of the following: magnesium, calcium, boron, rubidium, and others, typically in a soluble form and often as the respective chlorine salt. It will be understood that the process steps required for removing such impurities will vary with the presence or absence of impurity. Thus, if an impurity is not present, or if the content is such that the end product will satisfy requirements for a particular application, then no removal step is required as to that impurity.

Such removal steps will use methods which are known or will become available in the art.

After necessary removal steps have been performed, there may still remain a content of impurity, so subsequent removal steps may be used, which may be the same or different than a previous removal step.

The process of the present invention is widely applicable to all lithium-containing aqueous brines. Suitable brines occur in nature both as ground water in wells or mines and as surface water in the oceans and lakes, such as brines found naturally in Nevada, Argentina, and Chile. Brines can also be synthetically produced by the reaction of hydrochloric acid with lithium minerals to produce lithium chloride-containing brines. The hydrochloric acid for this purpose may be obtained by reacting the hydrogen and chlorine by-products of the electrolysis step of the present invention. Typically, such brines contain very low concentrations of lithium of the order of 50-500 ppm, or even less, although brines containing up to as much as 0.5% lithium may be found. While in theory, the process of the invention may be carried out with a brine of any concentration from very low up to saturation, it is obviously less feasible economically to operate on brines having a very low lithium content because of the time and size of the equipment which would be necessary. For this reason it is desirable, as a preliminary step, to concentrate naturally occurring dilute brines until the lithium concentration is raised to at least about 0.04% up to about 1%, and, preferably, at least about 0.1%.

Dilute brines may be concentrated in lithium content by any suitable method, although at present some sort of evaporative process is indicated because of the difficulty of chemically separating the constituents of the mixture of salts normally found in the brines. While evaporation may be carried out in any known manner, it is preferred to simply store the brines in ponds and permit concentration by solar evaporation over a period of time. Such solar evaporation tends to separate a part of the sodium and potassium chlorides which are less soluble than lithium chloride. Moreover, due to absorption of carbon dioxide from the air, a portion of the magnesium content may also be removed from basic brines in this manner as magnesium carbonate.

When the dilute brines have thus been brought to a lithium concentration of about 0.04 to 1% or preferably at least about 0.1%, the pH of the brine is desirably, but optionally, adjusted to a value in the range from about 10.5 to about 11.5, preferably about 11 to aid in the removal of the cationic impurities, i.e. the cations other than lithium, particularly magnesium, if that element is present in substantial amounts. This may be accomplished by the addition of any suitable alkaline material such as lime, sodium carbonate or calcium hydroxide, the primary consideration being low cost. The brine may then be concentrated further by solar evaporation, typically to contain about 0.5 to 1% lithium (i.e., about 3.1 to 6.2% lithium chloride). Inasmuch as carbon dioxide absorption from the air may have reduced the pH to about 9, it may again be adjusted to 10.5 to 11.5 by the addition of lime, calcium hydroxide or sodium carbonate to reduce the residual magnesium and calcium in solution to about 0.1%.

The brine is then further concentrated still further by any suitable means such as solar evaporation or, more rapidly, by submerged combustion according to techniques known in the art. The brines may again absorb carbon dioxide from the atmosphere during this process thus possibly again reducing the pH to about 9. In this way the brine is reduced in volume to a concentration of about 2 to about 7% lithium, i.e. about 12 to about 44% lithium chloride. The lithium chloride concentration is conveniently calculated by multiplying the lithium concentration by a factor of 6.1. Sodium and potassium chloride are substantially less soluble in the brine than lithium chloride, so substantially all of the sodium and potassium are removed when the lithium concentration exceeds about 40%. Lithium chloride itself reaches saturation in aqueous solution at a lithium content of about 7.1% or about 44% lithium chloride at ambient temperatures. This, therefore, is the upper limit to which concentration of the brines is practical without precipitating lithium chloride with attendant contaminants. As noted above, inasmuch as substantial amounts of sodium and potassium remain in solution until the lithium concentration reaches about 35%, that is the practical lower limit of the evaporative concentration step of the process, unless sodium and potassium cations are to be removed via recrystallization of the hydroxides in order to obtain high purity lithium.

Inasmuch as the thus concentrated and purified brine is to be further purified by electrolysis, it is preferable to remove any remaining interfering cations. In a preferred embodiment, the brine to be electrolyzed is diluted, if necessary, to a lithium content of about 2 to 5% (about 12 to 30% lithium chloride) to limit chloride ion migration during electrolysis and electrical efficiencies are actually improved at such concentrations. This dilution will not be necessary, of course, if the concentration step was not carried beyond the 5% lithium concentration. The removal of substantially all of the remaining interfering cations, which are normally primarily calcium and magnesium, and possibly iron, is accomplished by again raising the pH of the brine to about 10.5 to 11.5, preferably about 11. This may be done by the addition of any suitable alkaline material, but in order to obtain the best separation without contamination, it is preferred to add stoichiometric quantities of lithium hydroxide and lithium carbonate. In this manner, substantially all of the interfering cations are removed as magnesium hydroxide, calcium carbonate or as iron hydroxides. The lithium hydroxide and lithium carbonate for this purpose are readily available from the product of the process as will be seen below.

As mentioned above, the brine to be electrolyzed should be substantially free of interfering cations although, as a practical matter, small amounts of alkali metal ions such as sodium and potassium may be tolerated so long as the amount does not exceed about 5% by weight which will remain in solution during recrystallization. Cations which would seriously interfere with the electrolysis by precipitating in the cation permeable membrane such as iron, calcium and magnesium, must, however, be reduced to very low levels. The total content of such ions should, preferably not exceed about 0.004% although concentrations up to their solubility limits in the catholyte may be tolerated. Such higher concentrations could be used, if necessary, at the sacrifice of the operating life of the cell membrane. The content of anions other than the chloride ion in the brine to be electrolyzed should not exceed about 5%.

The catholyte may be composed of any suitable material containing sufficient ions to carry the current. While water alone may be employed subject to the foregoing limitation, it is preferred to supply the necessary ionization by the product to be produced, i.e. lithium hydroxide. The initial concentration of lithium hydroxide may vary from only sufficient to permit the cell to operate up to the saturation concentration under the prevailing pressure and temperature conditions. However, inasmuch as it is undesirable as a rule to permit lithium hydroxide to precipitate in the cell, and it is especially necessary to avoid precipitation of hydroxide within the membrane, saturation is to be avoided. Moreover, inasmuch as no available cation selective membrane is perfect and passes some anions, the higher concentration of hydroxyl ions in the catholyte the greater the migration of such ions through the membrane into the anolyte which is undesirable since such ions react with chloride ions to produce chlorine oxides thus decreasing the efficiency of production of chlorine as a by-product and reducing the current efficiency of the cell as a whole.

Even though the efficiency in the process described herein is high, the preferred operation will have a recycle of spent lithium chloride solution that is strengthened with freshly prepared purified lithium brine. This recycled brine is treated to remove any of the chlorine oxides that may have formed using methods known to those of skill in the art. Thus the process maintains its high efficiency as well as utilizing the valuable lithium stream to its maximum extent.

Any available semi-permeable electrolysis membrane which selectively passes cations and inhibits the passage of anions may be employed in the present process. Such membranes are well known to those of skill in the electrolysis art. Suitable commercial electrolysis membranes include the series available from E.I. DuPont de Nemours & Co. under the Nafion trademark. Such a selectively cation permeable membrane is placed between the anolyte brine to be electrolyzed and the catholyte described above to maintain physical separation between the two liquids.

A current of from about 100 amps/ft² to about 300 amps/ft² is passed through the membrane into the catholyte during electrolysis. Preferably, the current ranges from 150 amps/ft² to 250 amps/ft². It is preferred that the level of calcium and magnesium should be maintained at a level between <20 to <30 ppb combined Ca and Mg depending on current density, to avoid fouling of the membrane.

During electrolysis, the chloride ions in the anolyte migrate to the anode and are discharged to produce chlorine gas which may be recovered as a by-product and used to make hydrochloric acid, among several chemicals, as described below or by other processes. The hydroxyl ions in the catholyte, while attracted toward the anode, are substantially prevented from passing into the anolyte due to the impermeability of the membrane to such anions. The lithium ions, which enter the catholyte, associate themselves with hydroxyl ions derived from the water in the catholyte, thus liberating hydrogen ions which are discharged at the cathode with the formation of hydrogen which may also be collected as a by-product and used, e.g., with the resultant chlorine to make HCl. Alternatively, the hydrogen gas may be used as a heat source for energy production.

During the process, the lithium chloride in the anolyte brine is converted to lithium hydroxide in the catholyte; the efficiency of conversion being virtually 100% based upon the lithium chloride charged to the anode compartment of the cell. The electrolysis may be operated continuously until the concentration of lithium hydroxide reaches the desired level which may range up to 14% or just below saturation. This aqueous lithium hydroxide is of very high purity and will preferably contain no more than about 0.5% by weight cations other than lithium, most preferably less than 0.4 wt. %, and most preferably less than 0.2 wt. %. The lithium hydroxide monohydrate will also preferably contain less than 0.05 wt. % anions other than hydroxyl, most preferably less than 0.04 wt. %, and most preferably less than 0.02 wt. %. It is especially to be noted that the chloride content will not exceed 0.04 wt %, most preferably less than 0.03 wt. %, most preferably less than 0.02 wt %. Notably, the process of the invention yields this purity of lithium hydroxide monohydrate without the need for additional processing steps, although other processing steps my be used to further purify the product, if desired.

The high purity aqueous lithium hydroxide provided by the process of the invention may be used as is or it may be easily converted to other commercially desirable high purity lithium products. For example, the aqueous lithium hydroxide may be treated with carbon dioxide to precipitate high purity lithium carbonate containing no more than 0.05% chloride and typically only about 0.01%.

Alternatively, the aqueous lithium hydroxide may be converted to high purity crystalline lithium hydroxide monohydrate by simply evaporating the solution to dryness. More sophisticated crystallization techniques may be used employing partial crystallization, recycling and bleeding, to obtain crystalline lithium hydroxide monohydrate of the very highest purity.

It will be seen from the foregoing that part of the aqueous lithium hydroxide product may thus be converted to provide the lithium carbonate and lithium hydroxide employed in an earlier stage of the process to remove the iron, calcium and magnesium content of the concentrated brines.

It should also be apparent from the foregoing that the new process for the first time provides a method for obtaining lithium values from natural brines in high purity in the form of products directly useful in commercial applications without further purification and that the recovery of lithium from the concentrated brines is substantially 100%.

Additionally, once the lithium hydroxide solution, monohydrate crystals and hydrochloric acid solution have been produced they can be utilized as the starting material for other lithium containing compounds in addition to being sold into the marketplace. This can be done, for example, by using pure compressed CO₂ gas to react with the lithium hydroxide solution to precipitate a high purity lithium carbonate, which can also be utilized in certain battery applications.

An alternative is to use this lithium hydroxide solution to scrub combustion gases from fossil fuel burning resulting in a less pure carbonate but also reducing green house gas emissions.

Another example is to utilize the ultra pure lithium hydroxide and hydrochloric acid that result from the process of the present invention as reactants to reform a very high purity lithium chloride solution that would subsequently be crystallized and used to produce lithium metal that requires extremely low levels of impurities (e.g., for battery components).

Further examples include utilizing the inventive lithium hydroxide solution for forming lithium hypochlorite, which is a recognized sanitizer, production of high purity lithium fluorides and bromides and other lithium bearing compounds made via acid base reactions.

Recognizing the need for high purity in the lithium chloride solution, the process of the present invention utilizes an ion exchange resin that is effective in the reduction of the calcium and magnesium ions to levels that are less than 200 ppb combined. These levels have been shown to be acceptable in the lithium chloride electrochemical cells and may be achieved utilizing a high capacity macroporous weak acid cation exchange resin with a uniform bead size distribution. The resin may be regenerated with hydrochloric acid and lithium hydroxide from downstream processes saving on operating costs.

The resultant purified lithium chloride solution is between 15 and 30 wt % lithium (as lithium chloride) solution with the following typical analysis of impurities:

| Ca | Mg | Sr | Ba | Na | K | SO₄ | Si | B |
|---|---|---|---|---|---|---|---|---|
| <120 ppb | <50 ppb | <750 ppb | <1 ppm | <1,000 ppm | <500 ppm | <500 ppm | <1,000 ppm | <20 ppm |

It should be noted that at these low levels analysis requires great care to avoid contaminations resulting in a false high reading. Analytical process routinely used in the sodium chlor alkali field are not applicable.

This purified brine then undergoes electrolysis with an electrochemical cell. A typical electrochemical cell has three (3) primary elements, an anode, a permeable membrane, and a cathode. The process of the invention would use a perfluorosulfonic acid cation exchange membrane, for example one of DuPont's′ Nafion® families of membranes.

Due to the corrosivity of the solutions, and especially of lithium chloride, the electrodes are preferably made of highly corrosive-resistant material. Preferably the electrodes are coated titanium and nickel. A preferred cell arrangement is of a type called “pseudo zero gap” configuration, e.g., an Ineos FM01 with a flat plate anode with a turbulence promoting mesh on the anolyte side to both promote turbulence and to hold the membrane away from the anode surface. This arrangement is preferred to a more traditional zero gap arrangement to avoid premature damage or failure of the anode coating due to a potentially high pH gradient region of the area immediately adjacent to the anode.

Preferably, the cathode side electrode is a lantern blade design to promote turbulence and gas release.

The overall and half reactions at the electrodes of the are as follows:

2Cl—==>Cl₂+2e- Anodic Ionic Reaction

2H₂O+2e-==>H₂+2OH— Cathodic Ionic Reaction

2Cl—+2H₂O==>Cl₂+H₂+2OH⁻ Overall Ionic Reaction

2LiCl+2H₂O==>2H₂O+2LiOH Overall Reaction

Typical operating conditions of the cell described above are provided below:

| Make up brine concentration | 30-40 wt % Lithium Chloride |
|---|---|
| Catholyte Solution | 4-8 wt % Lithium Hydroxide |
| Current density (Ma/cm²) | 200-300 |
| Cell Temperature ° C. | 80-90 |
| Anolyte pH | 1.5-2 |
| Average Cell Voltage | 3.0-3.5 |
| Catholyte Product | 4-9 wt % |
| Anolyte concentration | 10-25 wt % Lithium Chloride |
| Catholyte Efficiency | 70-75% |
| Anolyte Efficiency | 95-99% |

One skilled in the art will understand that these are exemplary and not limiting, and will depend with variations in the process steps, equipment used, desired end product, and other factors.

Utilizing the latent heat in the catholyte solution lithium hydroxide monohydrate can be produced via, e.g., a simple vacuum cooling crystallization; utilizing standard available industrial equipment design for such a purpose.

The lithium hydroxide monohydrate product of the present invention is pure enough to be used in battery applications, and is an improved result compared to other lithium hydroxide processes which require additional washing or other processing steps in order to achieve the purity required for use with batteries.

The chlorine and hydrogen generated as a result of the electrochemical cells operation can be de-watered, and optionally compressed slightly. Chlorine and hydrogen react exothermally to form hydrogen chloride gas. Both gases pass through a burner nozzle and are ignited inside an appropriately constructed combustion chamber cooled by water. The hydrogen chloride gas produced is cooled and adsorbed into water to give hydrochloric acid at the desired concentration. The quality of the water used for adsorption will determine the purity of the resultant acid. Alternately, one skilled in the art may produce other chemicals from these streams.

Additional process steps may be added to the overall processes of the invention. For example, it may be necessary to purge the liquid in the electrolytic cell from time to time if, e.g., concentrations of ions exceed the range required for yielding the desired lithium hydroxide monohydrate product or, e.g., to maintain the proper functionality of the electrodes.

### DESCRIPTION OF PREFERRED EMBODIMENT

Referring to the FIGURE, which discloses a preferred embodiment of the method of the present invention, a lithium chloride containing brine (1) is provided, which may be natural or otherwise made available, e.g., from ore. This brine undergoes a primary purification step (2) to lower amounts of unwanted ions or other impurities. This may be accomplished, e.g., by precipitating magnesium, boron barium and calcium, or sodium, as insoluble salts via processes such as those described supra or that are otherwise known in the art, e.g., basic adjustment of the pH of the brine to precipitate hydroxides of unwanted ions. This brine may then be used for other processes utilizing such a brine (3) or, more relevant to the present application, may be subjected to a secondary purification step (4) with ion exchange such as described supra. Ultimately, the total weight of Ca and Mg in the brine prior to electrolysis is less than 150 ppb, through any combination of chemical, solar evaporation and or ion exchange processes.

The brine having less than a combined total of 150 ppb Ca and Mg ions is then subjected to electrolysis (5) with a cation selective permeable membrane to separate the anolyte from the catholyte. Lithium ions migrate through the membrane to form an aqueous catholyte containing substantially pure aqueous lithium hydroxide.

Rectifier (21) is connected to an AC power source (not shown provides DC current to the anode and cathode of the electrolysis cell (5). Preferably, cooling water is circulated through the rectifier to remove excess heat and improve efficiency of operation of the rectifier. Cells are started up at 1.5 kA/m² and then raised to operating conditions of 2-3 kA/m² as production demand requires. This is done at an operating voltage of 3-3.5 volts, again driven by production demands. Over time as cell efficiency deteriorates the required current density will increase as will the required voltage for the same production requirements.

Anolyte (14) may be reused in the process by addition of HCl from either an outside source or from the process, and can be fed back into the lithium chloride feed stream (1). Preferably the anolyte is purified (15) prior to mixing with the lithium chloride feed stream (1). In a preferred embodiment the anolyte leaves the cells in a concentration of <20 wt % and more preferably <19.5 wt %. This spent anolyte may contain chlorates and/or hypochlorite due to migration across the membrane of the OH⁻ ion. These ions will preferably be neutralized by adding HCl to the recirculated spent anolyte as well as to the fresh anolyte.

The hydrolysis yields chlorine (6) and hydrogen (7) gases as byproducts. These may then be combined in a hydrochloric acid synthesis unit to yield hydrochloric acid which is then stored (9). A chlorine absorber (10) is preferably provided to operate during emergency situations for readily apparent safety reasons and will absorb chlorine gas in the event of a problem with the HCl synthetic pathway.

In this preferred embodiment, a tail gas scrubber (12) receives demineralized water, e.g., from a process stream or directly, receives hydrogen and/or chlorine gases fed to the HCl synthesis unit (8) to remove impurities from the gas streams such as residual chlorine gases not reacted with the hydrogen in the HCl synthesis unit. This unit (12) ensures compliance with air emissions requirements.

The catholyte (13) is an aqueous lithium hydroxide containing solution having less than 150 ppb combined calcium and magnesium as an impurity. Lithium hydroxide can then be separated from the catholyte by, e.g., caustic concentration and/or crystallization (16) to precipitate the lithium hydroxide monohydrate, and these crystals may then be centrifuged and optionally dried (17) hydroxide monohydrate or lithium carbonate may be separated. Steam my be used in the crystal purification process. The recovered lithium hydroxide monohydrate crystals are then stored in their final packaging as required. (18).

In this preferred embodiment, the catholyte may be cooled (19), e.g., by addition of cool water prior to recovery of the lithium hydroxide monohydrate crystals, or, the catholyte may be returned for further electrolysis (20).

Process condensate can be obtained from the condensation of vapors from either cell operation or from water evaporation in the crystallization operation. In order to avoid to high concentration of OH⁻ ions and enhance Li ion transport across the membrane process condensate is added to levels resulting in the optimal performance of the cell.

In an alternative embodiment, catholyte (13) may be used in other processes directly (22), without recovery of lithium hydroxide as crystals.

After caustic concentration and/or drying (16) of the crystals, the remaining solution, which may contain unrecovered lithium, may be purged (24) and recycled as a caustic addition (25) into the feed stream (1) for reprocessing to recover any unused lithium as the hydroxide. This will also help to adjust the pH of the anolyte feed stream which will be acidic from addition of acid, preferably hydrochloric acid produced during the process (26).

All references, patents, patent applications, publications, and other citations present herein are hereby incorporated by reference in its entirety for all purposes.

It is claimed:

1. A process for producing lithium hydroxide monohydrate crystals comprising steps of:
(a) concentrating a lithium containing brine that also contains sodium and optionally potassium to precipitate sodium an optionally potassium from the brine;
(b) optionally purifying the brine to remove or to reduce the concentrations of boron, magnesium, calcium, sulfate, and any remaining sodium or potassium;
(c) adjusting the pH of the brine to about 10.5 to 11 to further remove any cations other than lithium;
(d) further purifying the brine by ion exchange to reduce the total concentration of calcium and magnesium to less than 150 ppb;
(e) electrolyzing the brine to generate a lithium hydroxide solution containing less than 150 ppb total calcium and magnesium, with chlorine and hydrogen gas as byproducts; and
(f) concentrating and crystallizing the lithium hydroxide solution to produce lithium hydroxide monohydrate crystals.

2. The process of claim 1, wherein said lithium hydroxide solution in (f) is converted to a high purity lithium products, preferably high purity lithium carbonate.

3. The process of claim 1, further comprising centrifuging the lithium hydroxide monohydrate crystals.

4. The process of claim 3, further comprising drying said centrifuged crystals and subsequently packaging of the dried material.

5. The process of claim 1, wherein the brine is concentrated to a lithium concentration of from about 2% to about 7% prior to electrolysis.

6. The process of claim 1, wherein a lithium containing brine as in (a) is concentrated via solar evaporation.

7. The process of claim 1, wherein the amount of boron in the brine as in (b) is reduced via an organic extraction process or ion exchange.

8. The process of claim 1, wherein the amount of magnesium in the brine as in (b) is reduced via a controlled reaction with lime or slaked lime.

9. The process of claim 1, wherein the amount of magnesium in the brine as in (b) is reduced via a controlled reaction with lime and slaked lime.

10. The process of claim 1, wherein the amount of calcium in the brine as in (b) is reduced via oxalic acid treatment.

11. The process of claim 1, wherein the amount of sulfate in the brine as in (b) is reduced via barium treatment.

12. The process of claim 1, wherein the amount of sodium in the brine as in (b) is reduced via fractional crystallization.

13. The process of claim 1, wherein the pH of the brine is adjusted to a value about 11.

14. The process of claim 1, wherein the pH of the brine is adjusted by adding lithium hydroxide and lithium carbonate in amounts stoichiometrically equal to the content of iron, calcium and magnesium.

15. The process of claim 1, wherein the pH of the brine is adjusted by adding lithium hydroxide and lithium carbonate which are obtained from the products of the process of claim 1.

16. The process of claim 1, wherein the total concentration of calcium and magnesium in the brine is reduced to less than 150 ppb via ion exchange.

17. The process of claim 1, wherein during the electrolysis step, a semi-permeable membrane which selectively passes cations and inhibits the passage of anions is employed.

18. The process of claim 1, wherein during the electrolysis step, the electrodes are made of highly corrosive-resistant material.

19. The process of claim 1, wherein during the electrolysis step, the electrodes are made of coated titanium and nickel.

20. The process of claim 1, wherein during the electrolysis step, the electrochemical cell is arranged in a “pseudo zero gap” configuration.

21. The process of claim 1, wherein during the electrolysis step, a monopolar membrane cell is used, preferably an Ineos Chlor FM1500 monopolar membrane.

22. The process of claim 1, wherein during the electrolysis step, the cathode side electrode is a lantern blade design to promote turbulence and gas release.

23. A process for producing hydrochloric acid wherein the process comprising steps of
(a) concentrating a lithium containing brine that also contains sodium and optionally potassium to precipitate sodium an optionally potassium from the brine;
(b) optionally purifying the brine to remove or to reduce the concentrations of boron, magnesium, calcium, sulfate, and any remaining sodium or potassium;
(c) adjusting the pH of the brine to about 10.5 to 11 to further remove any cations other than lithium;
(d) further purifying the brine by ion exchange to reduce the total concentration of calcium and magnesium to less than 150 ppb;
(e) electrolyzing the brine to generate a lithium hydroxide solution containing less than 150 ppb total calcium and magnesium, with chlorine and hydrogen gas as byproducts; and
(f) producing hydrochloric acid via combustion of the chlorine gas with excess hydrogen.

24. The process of claim 23, wherein said lithium hydroxide solution in (e) is converted to a high purity lithium products, preferably high purity lithium carbonate.

25. The process of claim 24, further comprising concentrating and crystallizing the lithium hydroxide solution to produce lithium hydroxide monohydrate crystals.

26. The process of claim 25, further comprising drying said crystals.

27. The process of claim 23, wherein the brine is concentrated to a lithium concentration of from about 2% to about 7% prior to electrolysis.

28. The process of claim 23, wherein a lithium containing brine as in (a) is concentrated via solar evaporation.

29. The process of claim 23, wherein the amount of boron in the brine as in (b) is reduced via an organic extraction process.

30. The process of claim 23, wherein the amount of magnesium in the brine as in (b) is reduced via a controlled reaction with lime or slaked lime.

31. The process of claim 23, wherein the amount of magnesium in the brine as in (b) is reduced via a controlled reaction with lime.

32. The process of claim 23, wherein the amount of calcium in the brine as in (b) is reduced via oxalic acid treatment.

33. The process of claim 23, wherein the amount of sulfate in the brine as in (b) is reduced via barium treatment.

34. The process of claim 23, wherein the amount of sodium in the brine as in (b) is reduced via fractional crystallization.

35. The process of claim 23, wherein the pH of the brine is adjusted to a value about 11.

36. The process of claim 23, wherein the pH of the brine is adjusted by adding lithium hydroxide and lithium carbonate in amounts stoichiometrically equal to the content of iron, calcium and magnesium.

37. The process of claim 23, wherein the pH of the brine is adjusted by adding lithium hydroxide and lithium carbonate which are obtained from the products of the process of claim 1.

38. The process of claim 23, wherein the total concentration of calcium and magnesium in the brine is reduced to less than 150 ppb via ion exchange.

39. The process of claim 23, wherein during the electrolysis step, a semi-permeable membrane which selectively passes cations and inhibits the passage of anions is employed.

40. The process of claim 23, wherein during the electrolysis step, the electrodes are made of highly corrosive-resistant material.

41. The process of claim 23, wherein during the electrolysis step, the electrodes are made of coated titanium and nickel.

42. The process of claim 23, wherein during the electrolysis step, the electrochemical cell is arranged in a “pseudo zero gap” configuration.

43. The process of claim 23, wherein during the electrolysis step, a monopolar membrane cell is used, preferably an Ineos Chlor FM1500 or other commercially available monopolar membrane cell.

44. The process of claim 23, wherein during the electrolysis step, the cathode side electrode is a lantern blade design to promote turbulence and gas release.

45. A process for producing lithium hydroxide monohydrate crystals comprising steps of:
(a) purifying a lithium containing brine that also contains sodium and optionally potassium to reduce the total concentration of calcium and magnesium to less than 150 ppb;
(b) electrolyzing the brine to generate a lithium hydroxide solution containing less than 150 ppb total calcium and magnesium, with chlorine and hydrogen gas as byproducts; and
(c) concentrating and crystallizing the lithium hydroxide solution to produce lithium hydroxide monohydrate crystals.

46. A process for producing hydrochloride acid wherein the process comprising steps of
(a) purifying a lithium containing brine that also contains sodium and optionally potassium to reduce the total concentration of calcium and magnesium to less than 150 ppb;
(b) electrolyzing the brine to generate a lithium hydroxide solution containing less than 150 ppb total calcium and magnesium, with chlorine and hydrogen gas as byproducts; and
(c) producing hydrochloric acid via combustion of the chlorine gas with excess hydrogen.

47. A process for producing both lithium hydroxide monohydrate and hydrochloride acid wherein the process comprising steps of
(a) purifying a lithium containing brine that also contains sodium and optionally potassium to reduce the total concentration of calcium and magnesium to less than 150 ppb;
(b) electrolyzing the brine to generate a lithium hydroxide solution containing less than 150 ppb total calcium and magnesium, with chlorine and hydrogen gas as byproducts; and
(c) concentrating and crystallizing the lithium hydroxide solution to produce lithium hydroxide monohydrate crystals; and
(d) producing hydrochloric acid via combustion of the chlorine gas with excess hydrogen.

48. Lithium hydroxide monohydrate containing less than 150 ppb Ca and Mg combined total, and preferably less than 50 ppb total, and most preferably less than 15 ppb combined total.

49. Aqueous lithium hydroxide containing less than 150 ppb total Ca and Mg and preferably less than 50 ppb total, and most preferably less than 15 ppb combined total.
